(19) United States
(12) Patent Application Publication
(10) Pub. No.: US 2023/0310974 A1
(43) Pub. Date: Oct. 5, 2023

(54) Robotic Pin Setter Device

(71) Applicant: Larry Horton, Corning, NY (US)

(72) Inventor: Larry Horton, Corning, NY (US)

(21) Appl. No.: 18/154,901

(22) Filed: Jan. 16, 2023

Related U.S. Application Data
(60) Provisional application No. 63/327,116, filed on Apr. 4, 2022.

(51) Int. Cl. A63D 5/08; B25J 11/00; B25J 9/16

(52) U.S. Cl. CPC A63D 5/08; B25J 11/003; B25J 9/1697; B25J 9/1687

(57) ABSTRACT

The present invention relates to a novel robotic pin setter device. The device is a robotic pin setter that performs all functions of typical pin setters for standard bowling operations on two lanes simultaneously. The device comprises a housing component with a plurality of robotic arms that act to reset all ten pins quickly on both lanes. The plurality of robotic arms are each attached to a base component secured within the housing component via a mechanical linkage or rotational center pin or any other suitable securing means as is known in the art. The housing component further comprises an object recognition device and a control unit.

### CROSS-REFERENCE TO RELATED APPLICATION

The present application claims priority to, and the benefit of, U.S. Provisional Application No. 63/327,116, which was filed on Apr. 4, 2022, and is incorporated herein by reference in its entirety.

### FIELD OF THE INVENTION

The present invention relates generally to the field of robotic pin setter devices. More specifically, the present invention relates to an improved robotic pin setter device that provides users with a robotic pin setter capable of resetting two lanes simultaneously. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in robotic pin setter devices. Generally, bowling centers must be equipped with a pin resetting mechanism. Each mechanism typically covers a single lane for bowlers. Thus, a malfunctioning pin reset mechanism will force a lane to shut down. Accordingly, bowlers will not be able to participate when the machines are not working, ultimately resulting in financial losses for the bowling alley.

It would be desirable to provide a bowling system that functions to reset the pins on more than one lane at a time, allowing users the ability to bowl faster and more efficiently. Further, there is a need in the art for a pin setter device that creates less maintenance for a bowling alley, requiring less pin setter devices per lane. Accordingly, the disclosed device performs all the functions of typical pin setters but for more than one lane.

Therefore, there exists a long-felt need in the art for a robotic pin setter device that provides users with a robotic pin setter capable of resetting two lanes simultaneously. There is also a long-felt need in the art for a robotic pin setter device that features multiple robotic arms to reset all ten pins quickly on both lanes. Further, there is a long-felt need in the art for a robotic pin setter device that increases the speed at which users can bowl for improved entertainment value with their friends and family. Moreover, there is a long-felt need in the art for a device that makes bowling a more enjoyable experience, possibly leading to higher participation from children and adults. Further, there is a long-felt need in the art for a robotic pin setter device that performs all functions of typical pin setters for bowling operation. Finally, there is a long-felt need in the art for a robotic pin setter device that provides users with a device that saves time and money for bowling alleys.

The subject matter disclosed and claimed herein, in one embodiment thereof, comprises a robotic pin setter device. The device is a robotic pin setter that performs all functions of typical pin setters for standard bowling operations on two lanes simultaneously. The device comprises a housing component with a plurality of robotic arms that act to reset all ten pins quickly on both lanes. The plurality of robotic arms are each attached to a base component secured within the housing component via a mechanical linkage or rotational center pin or any other suitable securing means as is known in the art. The housing component comprises a video camera, communications networking component, CPU, wireless transmitter/receiver, and power supply. The video camera is in communication with the CPU and a touchscreen which allows users to input scores, as well as receive directions for carrying out procedures.

In this manner, the robotic pin setter device of the present invention accomplishes all of the foregoing objectives and provides users with a device that saves time and money when operating a bowling alley. The device provides users with a convenient way to reset multiple bowling lanes simultaneously. The device can be a new construction or retrofitted on existing equipment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a robotic pin setter device. The device comprises an object recognition device for detecting a bowling pin and the orientation of the bowling pin, wherein the orientation of the bowling pin encompasses a vertical orientation and a horizontal orientation of the bowling pin; at least one robotic arm which is designed for gripping and holding the bowling pin and for setting up the bowling pin onto a predefined desired position; and a control unit which is designed to evaluate data of the object recognition device and to activate the robotic arms depending on the predefined desired position of the bowling pin and/or on the detected orientation of the bowling pin.

Generally, devices for setting up bowling pins are sometimes called pinsetters and should be capable of placing a multitude of toppled bowling pins upright into a predefined position within less than 30 seconds.

Bowling pins in the context of this document are to be understood as cone-shaped, cylinder-shaped and/or rod-shaped objects which are typically toppled by a user by way of a ball. If a bowling pin is in a horizontal orientation, then this can also be termed as a “toppled bowling pin”. If a bowling pin is in a vertical orientation, then this can be termed as a “bowling pin left standing”.

A bowling lane typically comprises an approach, a foul line, a lane (run surface), a pin deck, a pit and/or at least one gutter. The approach is the region in which the players move in order to carry out their throw. The foul line is usually a line which is marked in black, and which delimits the approach and the lane from one another. The foul line is often connected to a control unit by a light barrier. If the light barrier is triggered, then an F (foul) is registered, and the toppled pins do not count. The lane is the mostly 60 feet long region between the approach and the pin deck. This region is not usually stepped on by the players. The ball runs through this region on its path to the pins which stand on the pin deck. The lane is usually oiled in regions, typically to protect the coating of the lane. The pin deck is the region in which the bowling pins stand or in which toppled over bowling pins are set up again. The pit connects to the region of the pin deck in the longitudinal direction. The pit is the region into which the toppled bowling pins are pushed by a pusher or into which the bowling pins are knocked by the ball. The at least one gutter extends laterally (to the right or left) next to the lane and the pin deck.

In one embodiment, the device permits a rapid set up of the bowling pins, i.e., the device ensures a set up within 30 seconds or less. Furthermore, the bowling pins can be set up into the predefined desired position with high precision by way of at least one robotic arm, however typically multiple robotic arms are utilized to set up the bowling pins. Generally, in the case of a bowling game, ten bowling pins are arranged in an isosceles triangle or equilateral triangle, wherein an apex of the triangle points in the direction of the bowling player or user.

In one embodiment, a large flexibility on setting up the bowling pins can be achieved by the plurality of robotic arms used for setting up the bowling pins. For example, a multitude of bowling pins can be placed on the lane in a predefined arrangement. The bowling pins can therefore be arranged in the most varied of geometric shapes. The number of bowling pins can hereby be 9 or 10 or also greater than 10 or smaller than 9. The disclosed device permits arbitrary, predefined desired positions and arrangements of the bowling pins on the lane, by which means even new game types which were before not possible with the previous setting-up devices can be conceived.

In one embodiment, the plurality of robotic arms can have at least an idle position and a gripping position. The idle position of the robotic arms should be designed in a manner such that the robotic arms in the idle position does not inhibit a throw of the bowling ball by a user.

In one embodiment, the plurality of robotic arms comprise a gripping device for gripping and holding the bowling pins. The gripping device can be a mechanical, a pneumatic, and/or a magnetic gripping device. The use of a magnetic gripping device has the advantage that an exact gripping is not necessary. Furthermore, gripping is usually possible at different gripping points of the bowling pin. For this, the bowling pin should comprise at least one magnet and/or at least a ferromagnetic material, such as iron, cobalt, or nickel. In contrast, a mechanical or pneumatic gripping device has the advantage that the bowling pin is grippable in a precise manner, so that a precise set up of the bowling pin onto the predefined position is possible. Further, a combination of a magnetic, mechanical, and/or pneumatic gripping device is likewise conceivable.

In one embodiment, the plurality of robotic arms can be designed for gripping and holding the bowling ball and for moving the bowling ball onto a predefined desired position. Furthermore, the control unit can be designed to activate the plurality of robotic arms in dependence on the detected position of the bowling ball.

In one embodiment, the gripping device can comprise a sensor which is designed for recognizing the holding of the bowling pin and/or the bowling ball. The sensor of the gripping device in turn, can be connected to the control unit. Thus, in one embodiment, the robotic arms cannot be moved or rotated by the control unit until the sensor indicates that the bowling pin or the bowling ball is securely held by the gripping device of the robotic arm.

In a further embodiment, if the robotic arms or a part, such as the gripping device, of the robotic arms are defective, then the robotic arms can be completely or partly disassembled and the robotic arm or the respective part exchanged. If one of the robotic arms should fail during operation, then the bowling pins can still be set up with the other robotic arms. Furthermore, the speed for setting up the bowling pins is increased when additional robotic arms are utilized. In another embodiment, the movements of the robotic arms and/or of the pusher are synchronized or coordinated with one another by the control unit, thus preventing collisions of the robotic arms.

In one embodiment, the plurality of robotic arms are designed to grip and/or set up bowling pins in a manner engaging multiple lanes. Thus, the robotic arms are designed for gripping bowling pins which are located on at least two bowling lanes and/or setting up bowling pins onto at least two different bowling lanes. In particular, the plurality of robotic arms can grip bowling pins from different bowling lanes, hold them, and set them up onto different bowling lanes, successively or in an alternating manner, or simultaneously. For example, the plurality of robotic arms are dimensionable and/or positionable in a manner, such that they can grip bowling pins from different bowling lanes and/or place them onto different lanes. Herein, the person skilled in the art recognizes that the specific dimension and/or position of the robotic arms depend on the dimensions of the respective bowling lanes. After gripping the bowling pins, the robotic arms can hold the bowling pins and subsequently set up or place these pins onto a certain, desired or predefined position (i.e., onto the bowling lane or into the pit).

In one embodiment, the robotic arms are arranged in a stationary manner. The robotic arms can be designed for gripping bowling pins, which are located on adjacent bowling lanes and/or for setting up the bowling pins onto one of the adjacent bowling lanes. For example, it is conceivable to position the robotic arms between two bowling lanes so that the robotic arms can grip and/or set up bowling pins of both bowling lanes or of adjacent bowling lanes. In this case, the plurality of robotic arms are each attached to a base component secured within the housing component via a mechanical linkage or rotational center pin or any other suitable securing means as is known in the art. The base component would be positioned and secured between two adjacent bowling lanes.

In a further embodiment, the robotic arms are designed in a traversable manner. For example, the robotic arms can be arranged on or in a traversable vehicle, such as a carriage. The vehicle can comprise wheels, tires, or rollers. In this case, the robotic arms can be moved in accordance with requirements specific to that bowling lane, where bowling pins are to be picked up, put in place and/or set up. In this case, the bowling lanes do not need to be adjacent and one or more bowling lanes can be arranged between these bowling lanes. Further, the vehicle can be moved by way of a stepper motor, wherein the stepper motor is preferably activated by the control unit.

The stationary or traversable robotic arms can also be arranged above the bowling lane or bowling lanes at a certain height. In this case, the robotic arms grip downward in order to take a bowling pin from one of the bowling lanes. For this purpose, the stationary robotic arms can be fastened to a carrier which is arranged at a certain height above the bowling lane or bowling lanes. Further, the vehicle of the traversable robotic arms can be coupled to a rail or guide which is arranged at a certain height above the bowling lane or bowling lanes.

If several robotic arms are present, then the control unit can activate the robotic arms and/or the respective other robotic arms, in dependence on an operating state of the robotic arms. If a robotic arm is not cable of functioning, then the control unit can activate other robotic arms so that the other robotic arms can assume the functions of the non-functioning robotic arm. In another embodiment, the device comprises means for detecting an operational state of the robotic arm. The means for detecting the operational state can be connected to the control unit or be part of the control unit.

Typically, the bowling device can comprise at least two horizontally extending bowling lanes and a ball return device. Longitudinal axis of the bowling lanes are preferably aligned parallel to one another. In an embodiment, the robotic arms are designed to grip and/or set up bowling pins in a manner engaging (extending) over the lane(s). One can envisage the robotic arms being designed for gripping bowling pins which are located on the at least two bowling lanes. In an embodiment, the robotic arms are arranged in a stationary manner with respect to the bowling lanes, for example above or between two adjacent bowling lanes. In this case, the robotic arms can grip the bowling pins which are located on adjacent bowling lanes. If the robotic arms are designed in a traversable manner, then the robotic arms can be moved to a position in a manner such that the robotic arms can grip and/or set up bowling pins of the adjacent bowling lanes from this position.

In contrast to this, with conventional systems, the complete bowling lane is out of service if the respective setting-up appliance is defective. Thus, with the disclosed device, one can operate without any interruptions. Furthermore, maintenance costs can be lowered by way of the redundancy since less service personnel need to be present, in order to ensure an undisturbed, interruption-free operation of the bowling lanes.

In one embodiment, the object recognition device of the disclosed device is designed for detecting a position of the bowling pin. Thus, the orientation of the bowling pin provides information as to whether the bowling pin is standing or lying and specifies where the bowling pin is located on the lane or in the pit.

According to a further embodiment, the object recognition device can be designed for recognizing a certain bowling pin from a group of bowling pins. For this, the certain bowling pin preferably comprises a detection feature. The detection feature can be, for example, a certain color, material, or shape of the bowling pin. It is merely important for the object recognition device to be able to recognize the certain bowling pin via the detection feature. For example, a “golden bowling pin” can be set up onto the predefined position, for example facing the bowling player in a frontmost position. The user or bowling player in a competition situation can then attempt to knock over the golden bowling pin first.

In a further embodiment, the object recognition device is designed to detect a bowling ball and a position of the bowling ball, as well as placement of the bowling ball in a ball return device. In another embodiment, the object recognition device can further detect the plurality of robotic arms and/or a position of the robotic arms and/or an orientation of the plurality of robotic arms and/or a pivot position (swivel position) of the robotic arms. Furthermore, the object recognition device can be designed for detecting the lane, the pit, a ramp, the pusher and/or a human. In another embodiment, the object recognition device detects objects on the bowling lane and recognizes whether the object is a bowling pin or a bowling ball. In yet another embodiment, the control unit can automatically switch off the plurality of robotic arms when a human or animal is situated within a predefined distance from the robotic arms for safety reasons.

In one embodiment, the object recognition device comprises a sensor, such as a photo sensor, or a laser scanner such as a 3D laser scanner, or a video camera or a combination of these for recognizing the at least one bowling pin, the bowling ball, the robotic arm, the pit, the pusher, the ramp, and/or a human. Herein, the object recognition device preferably permits a 3D object recognition of the respective objects via a combination of the one or more 3D laser scanners, video cameras, and/or photo-sensors. Thus, the object recognition device can comprise one sensor or a multitude of sensors per bowling lane.

In one embodiment, the control unit of the disclosed device can be designed to activate the robotic arms in dependence on the detected position of the bowling pin. The detected position can encompass the predefined desired position and/or an actual position.

In another embodiment, the control unit can be designed to process or handle signals or data of an aforementioned sensor or of several of the aforementioned sensors (i.e., laser scanner, 3D laser scanner, video cameras, photo-sensors or a combination thereof) of the object recognition device.

In one embodiment, the device can further comprise a position sensor which is connected to the control unit for recognizing a position of the traversable robotic arms. The position sensor can be a unit which is different from the object recognition device, such as a GPS sensor which is fastened to the robotic arms. The position sensor can also be integrated into the stepper motor of the traversable robotic arms. A position/relative position of the vehicle can then be determined by counting the steps of the stepper motor. The position sensor can alternatively also be the object recognition device itself. The control unit can be designed to activate the traversable robotic arms in dependence on its actual position and/or to traverse (move) it into a desired position and subsequently activate it.

In one embodiment, the device comprises a pusher. The pusher can be designed to push a multitude of bowling pins which are located on the lane, into a pit. In operation, the control unit is connected to the pusher. The control unit can be designed to activate the pusher and the robotic arms simultaneously. Specifically, the control unit can be designed to activate the robotic arms depending on their current orientations and positions. In particular, it is advantageous if movements of the robotic arms and of the pusher are synchronized or coordinated with one another by way of the control unit.

In one embodiment, the control unit can comprise a microcontroller, a processor, a central processing unit (CPU), a microprocessor and/or a digital signal processor for the processing and/or handling of the signals and/or of the data of the aforementioned sensors. Hereby, a digital signal processor (DSP) can be designed for a continuous processing of digital signals, for example digital signals of the aforementioned sensors.

Furthermore, the control unit can comprise one or more memories, such as random access memory (RAM), read only memory (ROM), a hard disc, a magnetic storage medium and/or an optical drive. A program, such as software for processing or handling the data and/or the signals of a sensor or several of the aforementioned sensors can be stored in the memory. Additionally, the control unit also comprises a wireless transmitter/receiver for transmitting and receiving wireless signals and/or a communications networking component for connection with the internet, and other wireless robotic pin setter devices, etc.

In operation, after the first throw, all bowling pins on the lane, toppled as well as standing bowling pins are pushed into the pit by way of the pusher.

Thus, the plurality of robotic arms can for example, only grasp the vertically oriented bowling pins out of the pit and set them up onto the predefined desired position or onto the position which is detected by the object recognition device. Accordingly, it is only the number of bowling pins which remained standing after the first throw which are set up again.

Further, it has been found that after the first throw, it is simpler to push all bowling pins from the lane into the pit, and to thereafter grasp individual bowling pins out of the pit by way of the plurality of robotic arms and to subsequently set them up then to grasp toppled bowling pins between still standing bowling pins by way of the plurality of robotic arms and to put them in the pit, since in some cases, the standing bowling pins can be inadvertently knocked over.

After the second throw, all bowling pins which remain on the lane are pushed into the pit by the pusher. The plurality of robotic arms subsequently grip the bowling pins out of the pit and the plurality of robotic arms set up the bowling pins onto the predefined desired positions on the lane again.

In one embodiment, the previously mentioned pusher is removed. In this case, the control unit can activate the plurality of robotic arms in a manner such that the plurality of robotic arms pick-up the bowling pins in the horizontal orientation and place them into the pit, whereas the plurality of robotic arms leave the bowling pins in the vertical orientation standing. The activation of the plurality of robotic arms can hereby be affected after the first throw of the bowling ball and after the second throw of the bowling ball.

In one embodiment, the predefined position of the bowling pin or the predefined arrangement of the bowling pins or the number of bowling pins can be specified by a user via an input means which is connected to the control unit. For example, if a user wishes to practice his throwing technique given certain arrangements of bowling pins, he can then input or change the predefined position of the bowling pins or the arrangement of the bowling pins or the number of bowling pins via the input means. Typically, the input means is connected to the control unit. A user can specify the predefined desired position of the bowling pins or a predefined arrangement of the bowling pins (triangle, rectangle, rhombus, line, shaped line, etc.) on the lane and forward it to the control unit via the input means. The control unit and the input means can be connected to one another, i.e., optically by way of glass fibers, electrically by way of cables, or via a wireless communications device. The input means can be a touch screen, a keyboard, a mouse, a smartphone, etc., or other suitable input means as is known in the art.

Further, the input means allows for score keeping, internet access, as well as giving directions for carrying out procedures, etc., or any other suitable information as is known in the art.

An operating state of the robotic arms can be communicated to the control unit via the input means. If one of the robotic arms is no longer functioning due to a defect, then the operating state can be inputted at the input means. The control unit then activates the respective other robotic arms in dependence on this operational state so that the other robotic arms assume the functions of the non-functioning robotic arm. It is to be understood that the invention is not limited to a certain input means. Alternatively, or additionally, means for detecting an operational state of the robotic arms can be provided, said means displaying which operational state the respective robotic arms exhibit. These detection means can also be connected to the control unit. By way of the provision of redundant robotic arms, it can be ensured that the bowling lanes can also be played on, if one robotic arm or several robotic arms have broken down and need to be repaired.

Thus, in one embodiment, the control unit is connected to the object recognition device, to the input means, to the pusher, and to the robotic arms.

In one embodiment, the housing component also comprises a power supply. The power supply powers the plurality of robotic arms, as well as the housing component. The power supply can comprise a standard electrical connection, rechargeable batteries, or solar energy, etc., or any other suitable powering means as is known in the art.

In yet another embodiment, the robotic pin setter device comprises a plurality of indicia.

In yet another embodiment, a method of automatically resetting two lanes of bowling pins simultaneously is disclosed. The method includes the steps of providing a robotic pin setter device comprising a housing component with a plurality of robotic arms that act to reset all ten pins quickly on both lanes, a video camera, a CPU, a wireless transmitter/receiver, and a power supply. The method also comprises inputting scores via a touchscreen in communication with the video camera. Further, the method comprises resetting the pins in one lane via the device, as needed. Finally, resetting the pins in a second lane via the device, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the robotic pin setter device of the present invention in accordance with the disclosed architecture;

FIG. 2 illustrates a perspective view of one embodiment of the robotic pin setter device of the present invention showing the device installed between two lanes in accordance with the disclosed architecture;

FIG. 3 illustrates a perspective view of one embodiment of the robotic pin setter device of the present invention showing the pins being reset in the first lane in accordance with the disclosed architecture;

FIG. 4 illustrates a perspective view of one embodiment of the robotic pin setter device of the present invention showing the pins fully reset in accordance with the disclosed architecture;

FIG. 5 illustrates a perspective view of one embodiment of the robotic pin setter device of the present invention showing the pins being reset in the second lane in accordance with the disclosed architecture;

FIG. 6 illustrates a block diagram of the robotic pin setter device of the present invention disclosing the housing component comprising the object recognition device, the control unit, and the robotic arms in communication with each other in accordance with the disclosed architecture; and

FIG. 7 illustrates a flowchart showing the method of automatically resetting two lanes of bowling pins simultaneously in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a robotic pin setter device that provides users with a robotic pin setter capable of resetting two lanes simultaneously. There is also a long-felt need in the art for a robotic pin setter device that features multiple robotic arms to reset all ten pins quickly on both lanes. Further, there is a long-felt need in the art for a robotic pin setter device that increases the speed at which users can bowl for improved entertainment value with their friends and family. Moreover, there is a long-felt need in the art for a device that makes bowling a more enjoyable experience, possibly leading to higher participation from children and adults. Further, there is a long-felt need in the art for a robotic pin setter device that performs all functions of typical pin setters for bowling operation. Finally, there is a long-felt need in the art for a robotic pin setter device that provides users with a device that saves time and money for bowling alleys.

The present invention, in one exemplary embodiment, is a novel robotic pin setter device. The device comprises a housing component with a plurality of robotic arms that act to reset all ten pins quickly on both lanes. The plurality of robotic arms are each attached to a base component secured within the housing component via a mechanical linkage or rotational center pin or any other suitable securing means as is known in the art. The housing component comprises a video camera, communications networking component, CPU, wireless transmitter/receiver, and power supply. The video camera is in communication with the CPU and a touchscreen, which allows users to input scores, as well as receive directions for carrying out procedures.

The present invention also includes a novel method of automatically resetting two lanes of bowling pins simultaneously. The method includes the steps of providing a robotic pin setter device comprising a housing component with a plurality of robotic arms that act to reset all ten pins quickly on both lanes, a video camera, a CPU, a wireless transmitter/receiver, and a power supply. The method also comprises inputting scores via a touchscreen in communication with the video camera. Further, the method comprises resetting the pins in one lane via the device, as needed. Finally, resetting the pins in a second lane via the device, as needed.

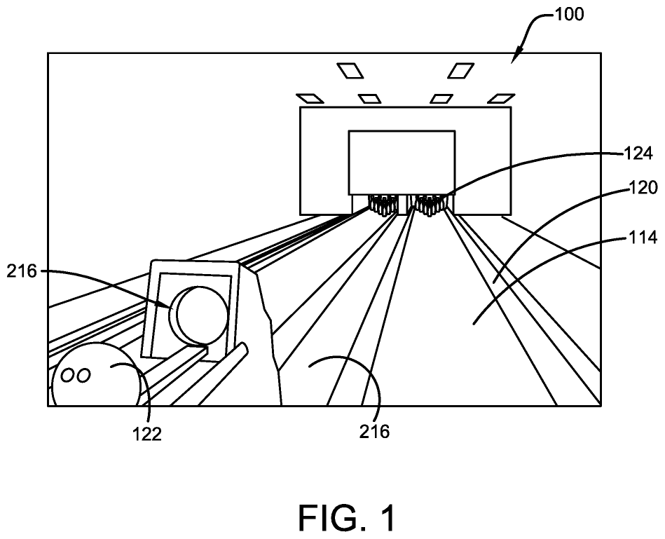

Referring initially to the drawings, FIG. 1 illustrates a perspective view of one embodiment of the robotic pin setter device 100 of the present invention. In the present embodiment, the robotic pin setter device 100 is an improved robotic pin setter device 100 that simultaneously resets two lanes of bowling pins. Specifically, the device 100 is an improved robotic pin setter device. The robotic pin setter device 100 comprises a housing component 102 with a plurality of robotic arms 104 that function to reset all ten pins quickly on both lanes. Specifically, the plurality of robotic arms 104 are designed for gripping and holding the bowling pins 108 and for setting up the bowling pins 108 in a predefined desired position.

The housing component 102 of the device 100 also comprises an object recognition device 106 for detecting a bowling pin 108 and the orientation of the bowling pin 108, wherein the orientation of the bowling pin 108 encompasses a vertical orientation and a horizontal orientation of the bowling pin 108. Further, the housing component 102 comprises a control unit 110 which is designed to evaluate data of the object recognition device 106 and to activate the robotic arms 104 in dependence on the predefined desired position of the bowling pins 108 and/or on the detected orientation of the bowling pins 108.

Generally, devices for setting up bowling pins 108 are sometimes called pinsetters and should be capable of placing a multitude of toppled bowling pins back upright into a predefined position within less than 30 seconds.

Bowling pins 108, in the context of this document, are to be understood as cone-shaped, cylinder-shaped, and/or rod-shaped objects which are typically toppled by a user by way of a ball. If a bowling pin 108 is in a horizontal orientation, then this can also be termed as a “toppled bowling pin”. If a bowling pin 108 is in a vertical orientation, then this can be termed as a “bowling pin left standing”.

A bowling lane typically comprises an approach, a foul line, a lane (run surface) 114, a pin deck 116, a pit 118 and/or at least one gutter 120. The approach is the region in which the players move, in order to carry out their throw. The foul line is usually a line which is marked in black, and which delimits the approach and the lane 114 from one another. The foul line is often connected to a control unit by a light barrier. If the light barrier is triggered, then an F (foul) is registered and the toppled pins 108 do not count. The lane 114 is the mostly 60 feet long region between the approach and the pin deck 116. This region is not usually stepped on by the players. The ball 122 runs through this region on its path to the pins 108 which stand on the pin deck 116. The lane 114 is usually oiled in regions, typically to protect the coating of the lane 114. The pin deck 116 is the region, in which the bowling pins 108 stand or in which toppled over bowling pins 108 are set up again. The pit 118 connects to the region of the pin deck 116 in the longitudinal direction. The pit 118 is the region into which the toppled bowling pins 108 are pushed by a pusher 124 or into which the bowling pins 108 are knocked by the ball 122. The at least one gutter 120 extends laterally (to the right or left) next to the lane 114 and the pin deck 116.

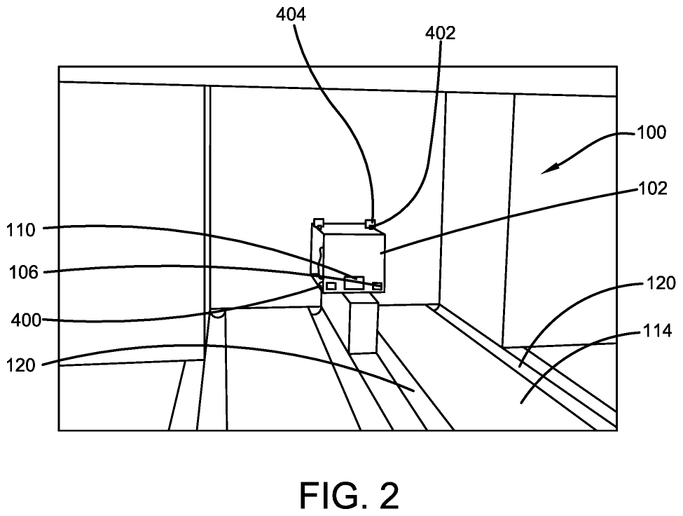

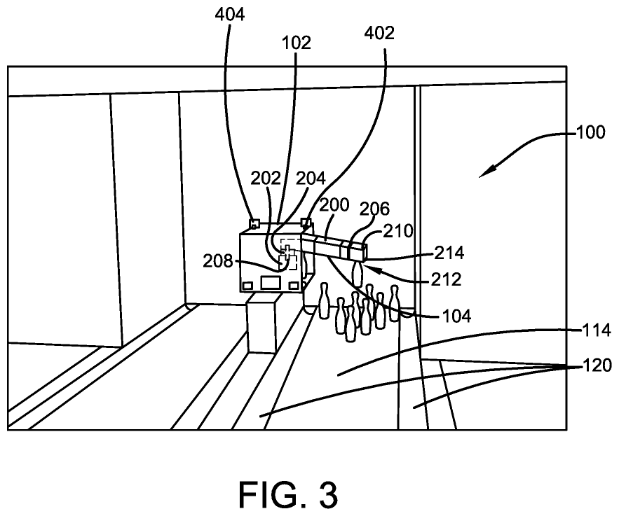

As shown in FIGS. 2-3, the device 100 permits a rapid set up of the bowling pins 108, i.e., the device 100 ensures a set up within 30 seconds or less. Furthermore, the bowling pins 108 can be set up into the predefined desired position with high precision by way of at least one robotic arm 104, however typically multiple robotic arms 104 are utilized to set up the bowling pins 108. Generally, in the case of a bowling game, ten bowling pins 108 are arranged in an isosceles triangle or equilateral triangle, wherein an apex of the triangle points in the direction of the bowling player or user.

Further, a large flexibility on setting up the bowling pins 108 can be achieved by the plurality of robotic arms 104 used for setting up the bowling pins 108. For example, a multitude of bowling pins 108 can be placed on the lane 114 in a predefined arrangement. The bowling pins 108 can therefore be arranged in the most varied of geometric shapes. The number of bowling pins 108 can hereby be 9 or 10 or also greater than 10 or smaller than 9. The disclosed device 100 permits arbitrary predefined desired positions and arrangements of the bowling pins 108 on the lane 114, by which means even new game types which were before not possible with the previous setting-up devices, can be conceived.

Additionally, the housing component 102 comprises a plurality of robotic arms 104. Any suitable number of robotic arms 104 can be utilized as is known in the art. The robotic arms 104 are designed for gripping and holding a bowling pin 108. Furthermore, the robotic arms 104 are designed for setting up the bowling pins 108 onto a predefined desired position. The robotic arms 104 can be multi-axis robotic arms and can comprise several arm segments 200. In one embodiment, the robotic arms 104 each comprise a base 202, on which a platform 204 is rotatable arranged about a vertical axis. A pivot arm segment 206 is pivotably arranged on the platform 204. A further arm segment which for example can be designed as a rotation arm segment 208 is arranged on the pivot arm segment 206. A gripping arm segment 210, which comprises a rotation axis, is arranged on the rotation arm segment 208. A gripping device 212 can be arranged on the gripper arm segment 210. The gripping device 212 can be a pneumatic, mechanical, and/or magnetic gripping device. The gripping device 212 can comprise a sensor 214 which is designed for recognizing a holding of the bowling pin 108. The robotic arms 104 have at least one idle position and a gripping position. Thus, in the idle position, one can ensure that the robotic arms 104 do not inhibit a throw of a bowling player or of a user of the lane 114.

Furthermore, as stated supra, the gripping device 212 of the plurality of robotic arms 104 can be a mechanical, a pneumatic, and/or a magnetic gripping device. The use of a magnetic gripping device has the advantage that an exact gripping is not necessary. Furthermore, gripping is usually possible at different gripping points of the bowling pin 108. For this, the bowling pin 108 should comprise at least one magnet and/or at least a ferromagnetic material, such as iron, cobalt, or nickel. In contrast, a mechanical or pneumatic gripping device has the advantage that the bowling pin 108 is grippable in a precise manner so that a precise set up of the bowling pin 108 onto the predefined position is possible. Further, a combination of a magnetic, mechanical, and/or pneumatic gripping device is likewise conceivable.

Additionally, the plurality of robotic arms 104 can be designed for gripping and holding the bowling ball 122 and for moving the bowling ball 122 into a predefined desired position, such as the ball return 216. Furthermore, the control unit 110 can be designed to activate the plurality of robotic arms 104 in dependence on the detected position of the bowling ball 122.

Further, the sensor 214 of the gripping device 212 is designed for recognizing the holding of the bowling pin 108 and/or the bowling ball 122. The sensor 214 of the gripping device 212 in turn, can be connected to the control unit 110. Thus, in one embodiment, the robotic arms 104 cannot be moved or rotated by the control unit 110 until the sensor 214 indicates that the bowling pin 108 or the bowling ball 122 is securely held by the gripping device 212 of the robotic arm 104.

In a further embodiment, if the robotic arms 104 or a part, such as the gripping device 212 of the robotic arms 104 are defective, then the robotic arms 104 can be completely or partly disassembled and the robotic arm 104 or the respective part exchanged. If one of the robotic arms 104 should fail during operation, then the bowling pins 108 can still be set up with the other robotic arms 104. Furthermore, the speed for setting up the bowling pins 108 is increased when additional robotic arms 104 are utilized. In another embodiment, the movements of the robotic arms 104 and/or of the pusher 124 are synchronized or coordinated with one another by the control unit 110, thus preventing collisions of the robotic arms 104.

Furthermore, the plurality of robotic arms 104 are designed to grip and/or set up bowling pins 108 in a manner engaging multiple lanes 114. Thus, the robotic arms 104 are designed for gripping bowling pins 108 which are located on at least two bowling lanes 114 and/or setting up bowling pins 108 onto at least two different bowling lanes 114. In particular, the plurality of robotic arms 104 can grip bowling pins 108 from different bowling lanes 114, hold them and set them up onto different bowling lanes 114, successively or in an alternating manner, or simultaneously. For example, the plurality of robotic arms 104 are dimensionable and/or positionable in a manner such that they can grip bowling pins 108 from different bowling lanes 114 and/or place them onto different lanes 114. Herein, the person skilled in the art recognizes that the specific dimension and/or position of the robotic arms 104 depend on the dimensions of the respective bowling lanes 114. After gripping the bowling pin 108, the robotic arms 104 can hold the bowling pin 108 and subsequently set up or place these pins 108 onto a certain, desired, or predefined position (i.e., onto the bowling lane 114 or into the pit 118).

In one embodiment, the robotic arms 104 are arranged in a stationary manner. The robotic arms 104 can be designed for gripping bowling pins 108 which are located on adjacent bowling lanes 114 and/or for setting up the bowling pins 108 onto one of the adjacent bowling lanes 114. For example, it is conceivable to position the robotic arms 104 between two bowling lanes 114 so that the robotic arms 104 can grip and/or set up bowling pins 108 of both bowling lanes 114 or of adjacent bowling lanes 114. In this case, the plurality of robotic arms 104 are each attached to a base component 218 secured within the housing component 102 via a mechanical linkage or rotational center pin or any other suitable securing means 220 as is known in the art. The base component 218 would be positioned and secured between two adjacent bowling lanes 114.

In a further embodiment, the robotic arms 104 are designed in a traversable manner. For example, the robotic arms 104 can be arranged on or in a traversable vehicle 222, such as a carriage. The vehicle 222 can comprise wheels 224, tires, or rollers. In this case, the robotic arms 104 can be moved in accordance with requirements of that bowling lane 114, where bowling pins 108 are to be picked up, put in place, and/or set up. In this case, the bowling lanes 114 do not need to be adjacent, and one or more bowling lanes 114 can therefore be arranged between these bowling lanes 114. Further, the vehicle 222 can be moved by way of a stepper motor 226, wherein the stepper motor 226 is preferably activated by the control unit 110.

The stationary or traversable robotic arms 104 can also be arranged above the bowling lane or bowling lanes 114, at a certain height. In this case, the robotic arms 104 grip downward in order to take a bowling pin 108 from one of the bowling lanes 114. For this purpose, the stationary robotic arms 104 can be fastened to a carrier 222 which is arranged at a certain height above the bowling lane or bowling lanes 114. Further, the vehicle 222 of the traversable robotic arms 104 can be coupled to a rail 228 or guide which is arranged at a certain height above the bowling lane or bowling lanes 114.

If several robotic arms 104 are present, then the control unit 110 can activate the robotic arms 104 and/or the respective other robotic arms 104, in dependence on an operating state of the robotic arms 104. If a robotic arm 104 is not cable of functioning, then the control unit 110 can activate other robotic arms 104 so that the other robotic arms 104 can assume the functions of the non-functioning robotic arm 104. In an embodiment, the device 100 comprises means for detecting an operational state 230 of the robotic arm 104. The means for detecting the operational state 230 can be connected to the control unit 110 or be part of the control unit 110.

Typically, the bowling device 100 can comprise at least two essentially horizontally extending bowling lanes 114 and a ball return device 216. Longitudinal axis of the bowling lanes 114 are preferably aligned parallel to one another. In an embodiment, the robotic arms 104 are designed to grip and/or set up bowling pins 108 in a manner engaging (extending) over the lane(s) 114. One can envisage the robotic arms 104 being designed for gripping bowling pins 108 which are located on the at least two bowling lanes 114. In an embodiment, the robotic arms 104 are arranged in a stationary manner with respect to the bowling lanes 114, for example above or between two adjacent bowling lanes 114. In this case, the robotic arms 104 can grip the bowling pins 108 which are located on adjacent bowling lanes 114. If the robotic arms 104 are designed in a traversable manner, then the robotic arms 104 can be moved to a position in a manner, such that the robotic arms 104 can grip and/or set up bowling pins 108 of the adjacent bowling lanes 114 from this position.

In contrast to this with conventional systems, the complete bowling lane 114 is out of service if the respective setting-up device is defective. Thus, with the disclosed device 100, one can operate without any interruptions. Furthermore, maintenance costs can be lowered by way of the redundancy since less service personnel need to be present, in order to ensure an undisturbed, interruption-free operation of the bowling lanes 114.

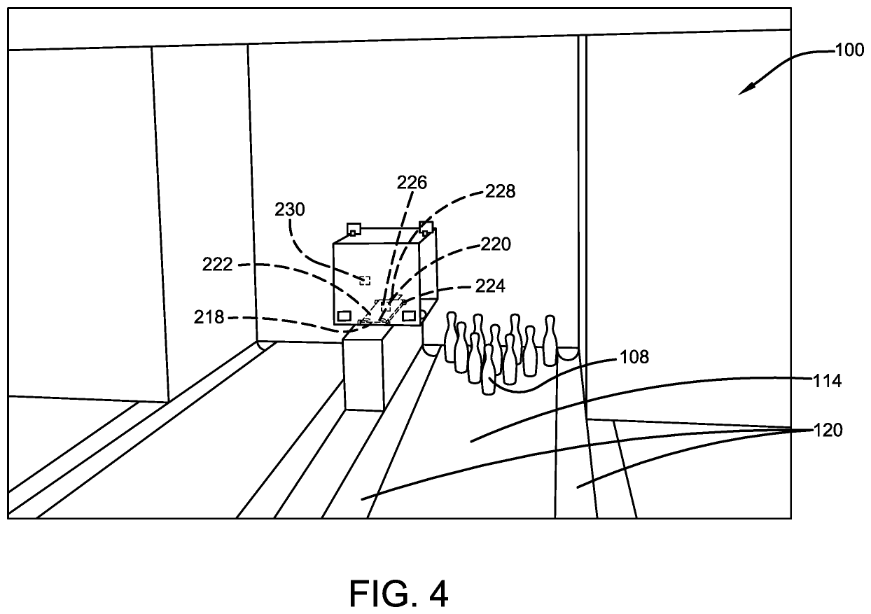

As shown in FIG. 4, the object recognition device 106 of the disclosed device 100 is designed for detecting a position of the bowling pin 108. Thus, the orientation of the bowling pin 108 provides information as to whether the bowling pin 108 is standing or is lying and specifies where the bowling pin 108 is located on the lane 114 or in the pit 118.

In one embodiment, the object recognition device 106 can be designed for recognizing a certain bowling pin 108 from a group of bowling pins 108. For this, the certain bowling pin 108 preferably comprises a detection feature (not shown). The detection feature can be, for example, a certain color, material, or shape of the bowling pin 108. It is merely important for the object recognition device 106 to be able to recognize the certain bowling pin 108 via the detection feature. For example, a “golden bowling pin” can be set up onto the predefined position, for example facing the bowling player in a frontmost position. The user or bowling player in a competition situation can then attempt to knock over the golden bowling pin first.

Furthermore, the object recognition device 106 is designed to detect a bowling ball 122 and a position of the bowling ball 122, as well as placement of the bowling ball 122 in a ball return device 216. In another embodiment, the object recognition device 106 can further detect the plurality of robotic arms 104, a position of the robotic arms 104, an orientation of the plurality of robotic arms 104, and/or a pivot position (swivel position) of the robotic arms 104. Furthermore, the object recognition device 106 can be designed for detecting the lane 114, the pit 118, a ramp, the pusher 124, and/or a human. In another embodiment, the object recognition device 106 detects objects on the bowling lane 114 and recognizes whether the object is a bowling pin 108 or a bowling ball 122. In yet another embodiment, the control unit 110 can automatically switch off the plurality of robotic arms 104 when a human or animal is situated within a predefined distance from the robotic arms 104 for safety reasons.

Additionally, the object recognition device 106 comprises a sensor 400, such as a photo sensor, a laser scanner 402 such as a 3D laser scanner, a video camera 404, or a combination of these for recognizing the at least one bowling pin 108, the bowling ball 122, the robotic arm 104, the pit 118, the pusher 124, the ramp, and/or a human. Herein, the object recognition device 106 preferably permits a 3D object recognition of the respective objects via a combination of the one or more 3D laser scanners 402, video cameras 404 and/or photo-sensors 400. Thus, the object recognition device 106 can comprise one sensor 400 or a multitude of sensors 400 per bowling lane 114.

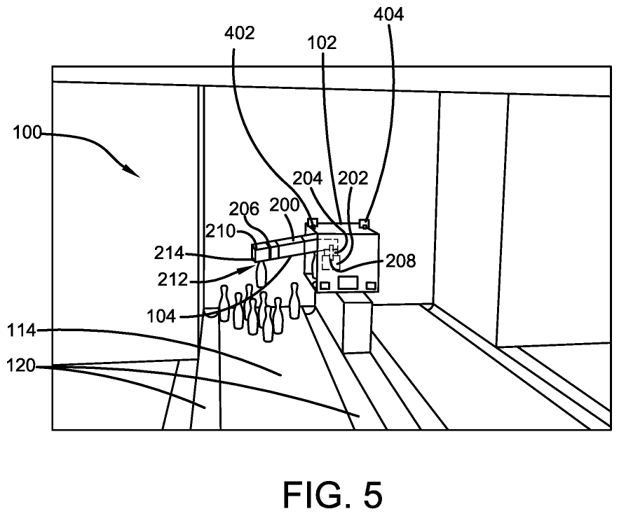

As shown in FIG. 5, the control unit 110 of the disclosed device 100 can be designed to activate the robotic arms 104 in dependence on the detected position of the bowling pin 108. The detected position can encompass the predefined desired position and/or an actual position.

Further, the control unit 110 can be designed to process or handle signals or data of an aforementioned sensor 400 or of several of the aforementioned sensors (i.e., laser scanner 402, 3D laser scanner, video cameras 404, photo-sensors 400 or a combination thereof) of the object recognition device 106.

In one embodiment, the device 100 can further comprise a position sensor 500 which is connected to the control unit 110 for recognizing a position of the traversable robotic arms 104. The position sensor 500 can be a unit which is different from the object recognition device 106, such as a GPS sensor which is fastened to the robotic arms 104. The position sensor 500 can also be integrated into the stepper motor 226 of the traversable robotic arms 104. A position/relative position of the vehicle 222 can then be determined by counting the steps of the stepper motor 226. The position sensor 500 can alternatively also be the object recognition device 106 itself. The control unit 110 can be designed to activate the traversable robotic arms 104 in dependence on its actual position and/or to traverse (move) it into a desired position and subsequently activate it.

Furthermore, the device 100 comprises a pusher 124. The pusher 124 can be designed to push a multitude of bowling pins 108 which are located on the lane 114 into a pit 118. In operation, the control unit 110 is connected to the pusher 124. The control unit 110 can be designed to activate the pusher 124 and the robotic arms 104 simultaneously. Specifically, the control unit 110 can be designed to activate the robotic arms 104 depending on their current orientations and positions. In particular, it is advantageous if movements of the robotic arms 104 and of the pusher 124 are synchronized or coordinated with one another by way of the control unit 110.

Specifically, the control unit 110 can be designed to activate the pusher 124 and the robotic arms 104 in a manner, such that if a first number of bowling pins 108 has toppled, the pusher 124 pushes all bowling pins 108 including the second number of standing bowling pins 108 into the pit 118. In contrast to the state of the art where standing bowling pins 108 are lifted from the pin deck 116 and it is only the toppled bowling pins 108 that are pushed into the pit 118. However, according to the present application, all bowling pins 108 which are located on the pin deck 116 are pushed into the pit 118. The robotic arms 104 subsequently grip bowling pins 108 out of the pit 118 and set up the bowling pins 108 onto the positions of the bowling pins 108 which are detected by the object recognition device 106.

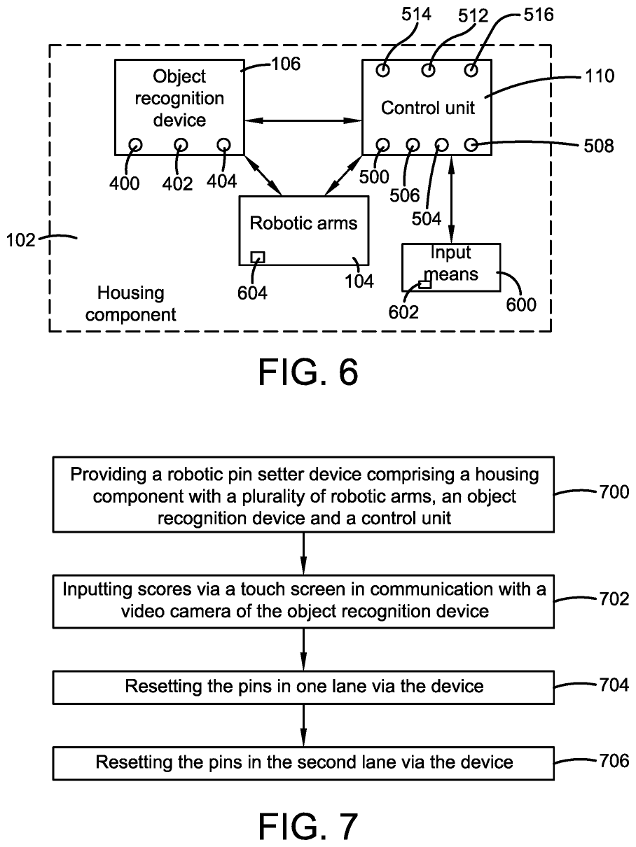

As shown in FIG. 6, the control unit 110 can comprise a microcontroller, a processor, a central processing unit (CPU) 504, a microprocessor 506, a digital signal processor 508 for the processing and/or handling of the signals and/or of the data of the aforementioned sensors 400. Hereby, a digital signal processor (DSP) 508 can be designed for a continuous processing of digital signals, for example digital signals of the aforementioned sensors 400.

Furthermore, the control unit 110 can comprise one or more memories 510, such as random access memory (RAM), read only memory (ROM), a hard disc, a magnetic storage medium and/or an optical drive. A program, such as software, for processing or handling the data and/or the signals of a sensor 400 or several of the aforementioned sensors can be stored in the memory 510. Additionally, the control unit 110 also comprises a wireless transmitter/receiver 512 for transmitting and receiving wireless signals and/or a communications networking component 514 for connection with the internet, and other wireless robotic pin setter devices, etc.

In operation, after the first throw, all bowling pins 108 on the lane 114, toppled as well as standing bowling pins 108, are pushed into the pit 118 by way of the pusher 124. Thus, the plurality of robotic arms 104 can, for example only grasp the vertically oriented bowling pins 108 out of the pit 118 and set them up onto the predefined desired position or onto the position which is detected by the object recognition device 106. Accordingly, it is only the number of bowling pins 108 which remained standing after the first throw which are set up again.

Furthermore, as stated supra, it has been found that after the first throw, it is simpler to push all bowling pins 108 from the lane 114 into the pit 118 and to thereafter, grasp individual bowling pins 108 out of the pit 118 by way of the plurality of robotic arms 104 and to subsequently set them up than to grasp toppled bowling pins 108 between still standing bowling pins 108 by way of the plurality of robotic arms 104 and to put them in the pit 118 since in some cases, the standing bowling pins 108 can be inadvertently knocked over.

After the second throw, all bowling pins 108 which remain on the lane 114 are pushed into the pit 118 by the pusher 124. The plurality of robotic arms 104 subsequently grip the bowling pins 108 out of the pit 118 and the plurality of robotic arms 104 set up the bowling pins 108 onto the predefined desired positions on the lane 114 again.

In one embodiment, the previously mentioned pusher 124 is removed. In this case, the control unit 110 can activate the plurality of robotic arms 104 in a manner such that the plurality of robotic arms 104 pick up the bowling pins 108 in the horizontal orientation and place them into the pit 118, whereas the plurality of robotic arms 104 leave the bowling pins 108 in the vertical orientation standing. The activation of the plurality of robotic arms 104 can hereby be affected after the first throw of the bowling ball 122 and after the second throw of the bowling ball 122.

Furthermore, the predefined position of the bowling pin 108 or the predefined arrangement of the bowling pins 108 or the number of bowling pins 108 can be specified by a user via an input means 600 which is connected to the control unit 110. For example, if a user wishes to practice his throwing technique given certain arrangements of bowling pins 108, he can then input or change the predefined position of the bowling pins 108 or the arrangement of the bowling pins 108 or the number of bowling pins 108 via the input means 600. Typically, the input means 600 is connected to the control unit 110. A user can specify the predefined desired position of the bowling pins 108 or a predefined arrangement of the bowling pins 108 (triangle, rectangle, rhombus, line, shaped line, etc.) on the lane 114 and forward it to the control unit 110 via the input means 600. The control unit 110 and the input means 600 can be connected to one another, i.e., optically by way of glass fibers, electrically by way of cables, or via a wireless communications device. The input means 600 can be a touch screen 602, a keyboard, a mouse, a smartphone, etc., or other suitable input means as is known in the art.

Further, the input means 600 allows for score keeping, internet access, as well as giving directions for carrying out procedures, etc., or any other suitable information as is known in the art, depending on the needs and/or wants of a user.

An operating state of the robotic arms 104 can be communicated to the control unit 110 via the input means 600. If one of the robotic arms 104 is no longer functioning due to a defect, then the operating state can be inputted at the input means 600. The control unit 110 then activates the respective other robotic arms 104 in dependence on this operational state so that the other robotic arms 104 assume the functions of the non-functioning robotic arm 104. It is to be understood that the invention is not limited to a certain input means 600. Alternatively, or additionally, means for detecting an operational state of the robotic arms 104 can be provided, said means displaying which operational state the respective robotic arms 104 exhibit. These detection means can also be connected to the control unit 110. By way of the provision of redundant robotic arms 104, it can be ensured that the bowling lanes 114 can also be played on, if one robotic arm 104 or several robotic arms 104 have broken down and need to be repaired.

Thus, in one embodiment, the control unit 110 is connected to the object recognition device 106, to the input means 600, to the pusher 124, to the robotic arms 104, and to any other suitable device or system, as needed.

Additionally, the housing component 102 also comprises a power supply 604. The power supply 604 powers the plurality of robotic arms 104, as well as the housing component 102 and its components. The power supply 604 can comprise a standard electrical connection, rechargeable batteries, and/or solar energy, etc., or any other suitable powering means as is known in the art, depending on the needs and/or wants of a user.

In yet another embodiment, the robotic pin setter device 100 comprises a plurality of indicia 606. The housing component 102 of the device 100 may include advertising, trademark, or other letters, designs, or characters, printed, painted, stamped, or integrated into the housing component 102 or the robotic arms 104, or any other indicia 606 as is known in the art. Specifically, any suitable indicia 606 as is known in the art can be included, such as, but not limited to, patterns, logos, emblems, images, symbols, designs, letters, words, characters, animals, advertisements, brands, etc., that may or may not be bowling or brand related.

One skilled in the art will understand that the robotic arms 104 may be manufactured of lightweight metals, such as aluminum and stainless steel, as well as carbon fiber, polycarbonates, etc., or any other suitable material as is known in the art depending on the needs and/or wants of a user. Additionally, the robotic arms 104 are also manufactured from a material that is water resistant or waterproof, or comprises a coating that is water resistant or waterproof.

FIG. 7 illustrates a flowchart of the method of automatically resetting two lanes of bowling pins simultaneously. The method includes the steps of at 700, providing a robotic pin setter device comprising a housing component with a plurality of robotic arms that act to reset all ten pins quickly on both lanes, a video camera, a CPU, a wireless transmitter/receiver, and a power supply. The method also comprises at 702, inputting scores via a touchscreen in communication with the video camera. Further, the method comprises at 704, resetting the pins in one lane via the device, as needed. Finally, at 706, resetting the pins in a second lane via the device, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “robotic pin setter device”, “pin setter device”, and “device” are interchangeable and refer to the robotic pin setter device 100 of the present invention.

Notwithstanding the foregoing, the robotic pin setter device 100 of the present invention can be of any suitable size and configuration as is known in the art without affecting the overall concept of the invention, provided that it accomplishes the above-stated objectives. One of ordinary skill in the art will appreciate that the robotic pin setter device 100 as shown in FIGS. 1-7 are for illustrative purposes only, and that many other sizes and shapes of the robotic pin setter device 100 are well within the scope of the present disclosure. Although the dimensions of the robotic pin setter device 100 are important design parameters for user convenience, the robotic pin setter device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A robotic pin setter device that simultaneously resets a set of bowling pins in a first lane and a second lane, the robotic pin setter device comprising:
a housing component;
a plurality of robotic arms;
an object recognition device; and
a control unit,
wherein the plurality of robotic arms grip and hold the set of bowling pins and set up the set of bowling pins in a predefined desired position;
wherein the objection recognition device detects a bowling pin of the set of bowling pins and an orientation of the bowling pin; and
further wherein the control unit evaluates data of the object recognition device and activates the plurality of robotic arms.

2. The robotic pin setter device of claim 1, wherein the orientation of the bowling pin comprises a vertical orientation and a horizontal orientation.

3. The robotic pin setter device of claim 2, wherein the plurality of robotic arms are activated in dependence on the predefined desired position of the set of bowling pins or a detected orientation of the set of bowling pins.

4. The robotic pin setter device of claim 1, wherein the plurality of robotic arms each comprise multi-axis robotic arms and several arm segments.

5. The robotic pin setter device of claim 4, wherein the plurality of robotic arms each comprise a base on which a platform is rotatable about a vertical rotation axis.

6. The robotic pin setter device of claim 5, wherein the plurality of robotic arms each comprise a gripping device for gripping the bowling pin.

7. The robotic pin setter device of claim 6, wherein the gripping device comprises a sensor which recognizes holding of the bowling pin.

8. The robotic pin setter device of claim 1, wherein the plurality of robotic arms are designed for gripping and holding a bowling ball.

9. The robotic pin setter device of claim 1, wherein if one of the plurality of robotic arms fails during operation, then the set of bowling pins can still be set up with another of the plurality of robotic arms.

10. The robotic pin setter device of claim 1, wherein the plurality of robotic arms are designed for gripping and setting up the set of bowling pins which are located on each of the first and second lanes.

11. The robotic pin setter device of claim 1, wherein the plurality of robotic arms are arranged in a stationary manner located on the first and second lanes.

12. The robotic pin setter device of claim 1, wherein the plurality of robotic arms are arranged in a traversable manner located on a vehicle with wheels, thereby allowing the plurality of robotic arms to move between the first and second lanes.

13. The robotic pin setter device of claim 1, wherein the object recognition device comprises a sensor, a laser scanner and a video camera.

14. The robotic pin setter device of claim 13, wherein the control unit processes data from the sensor, the laser scanner and the video camera of the object recognition device.

15. A robotic pin setter device that simultaneously resets a set of bowling pins on a first lane and a second lane, the robotic pin setter device comprising:
a housing component;
a plurality of robotic arms;
an object recognition device; and
a control unit,
wherein the plurality of robotic arms grip and hold the set of bowling pins and set up the set of bowling pins into a predefined desired position;
wherein the objection recognition device detects a bowling pin within the set of bowling pins and an orientation of the bowling pin;
wherein the orientation of the bowling pin comprises a vertical orientation and a horizontal orientation;
wherein the control unit evaluates data of the object recognition device and activates the plurality of robotic arms in dependence on the predefined desired position of the set of bowling pins or a detected orientation of the set of bowling pins;
wherein the plurality of robotic arms each comprise a base on which a platform is rotatable about a vertical rotation axis, a gripping device for gripping the set of bowling pins, and a sensor which recognizes holding of the set of bowling pin;
wherein the object recognition device comprises a sensor, a laser scanner and a video camera; and
further wherein the control unit comprises an input means, such as a touch screen or smartphone for score keeping, internet access, and giving directions for carrying out procedures.

16. The robotic pin setter device of claim 15, wherein the control unit comprises a position sensor for recognizing a position of the plurality of robotic arms.

17. The robotic pin setter device of claim 15 further comprising a pusher in communication with the control unit and designed to push a multitude of bowling pins which are located on the first lane or the second lane into a pit.

18. The robotic pin setter device of claim 15, wherein the control unit comprises a microcontroller, a processor, a central processing unit (CPU), a microprocessor or a digital signal processor for processing and handling of the data from the object recognition device.

19. The robotic pin setter device of claim 18, wherein the control unit comprises a memory, a wireless transmitter/receiver and a communications networking component.

20. A method of automatically resetting two lanes of bowling pins simultaneously, the method comprising the steps of:
providing a robotic pin setter device comprising a housing component with a plurality of robotic arms that act to reset a set of bowling pins on the two lanes, an object recognition device, and a control unit;
inputting scores via a touchscreen in communication with a video camera of the object recognition device;
resetting the set of bowling pins in a first lane via the robotic pin setter device, as needed; and
resetting the set of bowling pins in a second lane via the robotic pin setter device, as needed.
